(19) United States
(12) Patent Application Publication
(10) Pub. No.: US 2009/0295310 A1
(43) Pub. Date: Dec. 3, 2009

(54) Dual head inspection lamp

(76) Inventors: John Duerr, Massapequa Park, NY (US); Gustavo Garcia, East Setauket, NY (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 12/455,009

(22) Filed: May 26, 2009

Related U.S. Application Data
(60) Provisional application No. 61/130,291, filed on May 28, 2008.

(51) Int. Cl. H05B 37/02; F21L 4/00; F21L 4/04; F21V 9/00

(52) U.S. Cl. 315/297; 362/157; 362/202; 362/183; 362/231

(57) ABSTRACT

A dual head lamp having a housing, a first head removably attached to the first end of the housing, and a second head removably attached to the second end of the housing. The first head includes at least one non-white light emitting diode configured to emit light with a wavelength of between 250 nm and 500 nm for fluorescent inspection. The second head includes at least one light emitting diode the emits light having a wavelength that is different than the wavelength of the light emitted from the non-white light emitting diode in the first head. The second head is preferably arranged to emit light in a direction opposite the direction of the non-white light emitting diode. A removable battery compartment is within the housing and configured to hold one or more batteries. A button in communication with a circuit allows for control of power to the light emitting diodes.

### RELATED APPLICATION

This application is a United States regular patent application can claims priority from U.S. Provisional Application No. 61/130,291, filed May 28, 2008, the disclosure of which is incorporated herein by reference in its entirety.

### FIELD OF INVENTION

The present invention relates to lamps, and especially, but not exclusively, to a lamp for handheld use in leak detection and/or non destructive testing.

### BACKGROUND

Fluorescence is generally understood to be a property that enables certain materials to absorb light energy and radiate visible light at a longer wavelength than the absorbed light. Without being limited to any specific theory, it is widely accepted that electrons in fluorescent materials are excited upon being illuminated by light energy of a specific wavelength, and light energy of a longer wavelength is radiated from these materials as the electrons return to the unexcited or ground state. The specific excitation and radiation wavelengths are characteristics of the particular fluorescent materials. The apparent brightness of a fluorescent material's luminescence is dependent, among other factors, on the wavelength emitted by the material and the intensity of the incident radiation that excites the material. A fluorescent material that has its excitation peak at a specific wavelength may quickly emit a much reduced luminescence as the wavelength of incident light deviates from the excitation peak, and will lose the ability to fluoresce when the incident light does not have enough energy within the specific excitation range.

Lamps emitting radiation that excites fluorescence have been used for a wide variety of purposes, including, but not limited to, forensic inspection, readmission control, counterfeit currency detection, contamination inspection, non-destructive testing, and detecting leaks in air conditioning and other fluid-containing systems. The lamplight is commonly in the ultraviolet (UV) or in the visible blue-violet range, exciting a fluorescence somewhere in the visible range. The fluorescent material may be deliberately provided. For example, some banknotes have a fluorescent marker embedded in the paper and the lamplight is used to detect the otherwise hidden marker. In another example, one method for detecting leaks in an air conditioning system is through the use of fluorescent dyes that are added to and mixed with the refrigerant in the system, with the combination of refrigerant and dye circulating through the air conditioning system. This method was first pioneered by Spectronics Corporation, the assignee of the present invention. In these leak detection systems, the dye circulates through the system, eventually seeping out at the source of the leak. When exposed to a suitable light source, such as a UV or blue-violet light, the dye fluoresces, thus highlighting the source of the leak.

The visibility of the fluorescent response is increased when the intensity of other visible light is reduced, so that the fluorescent response is not masked or washed-out by other light. Thus, UV or blue-violet lamps directed in otherwise dark conditions at a system containing a UV or blue-violet responsive fluorescent material may reveal the fluorescent material glowing against the dark background.

For many purposes, a battery operated hand-held lamp that can be directed at less-accessible areas is desirable. Existing lamps powered by an external AC or DC power source have a trailing power lead that hinders maneuvering of the lamp, and cannot be used where a suitable power source is not available. Many existing battery powered lamps are heavy and bulky. The size and shape of the lamp typically hinders maneuvering of the lamp, makes the lamp awkward to grasp in the hand, or both. Small lamps do exist, for example, the UV-4B Series battery operated ultraviolet lamps manufactured and sold by Spectronics Corporation are only about 16 cm long by 2.5 cm wide by 5 cm from front to back. Those lamps are deep from front to back, with the actual light source positioned along one narrow side of the lamp unit. U.S. Pat. No. 6,491,408 discloses another type of handheld inspection lamp.

Because inspection often takes place in dark, less-accessible areas, a need exists for a battery-powered inspection lamp that is compact, easy to hold, and provides large amounts of the desired wavelength, while at the same time providing visible white light by which the user can navigate the dark areas.

### SUMMARY OF INVENTION

The present invention includes a lamp having a housing with a first end and a second end. A first head is removably attached to the first end. The first head includes at least one blue or UV light emitting diode configured to emit light through a first window of the first head in a direction substantially parallel to the length of the housing. A second head is removably attached to the second end of the housing. The second head includes, in one embodiment, at least one white or other visible light emitting diode configured to emit light through a second window of the second head in a direction substantially parallel to the length of the housing and opposite the direction of the blue/UV light emitting diode. In another embodiment, the second head includes a light emitting diode for emitting light with a wavelength that is different than the wavelength of light emitted from the light emitting diode in the first head. Within the housing, and in communication with a circuit within the housing is a removable battery compartment that is configured to hold one or more batteries. A single button is in communication with the circuit allows for control of power to the at least one blue/UV light emitting diode and the at least one white/visible light emitting diode.

Although the drawings illustrate the housing as being straight, it is also contemplated that one or both of the lamp heads may be mounted on an angle to the housing or a handle portion of the housing.

### BRIEF DESCRIPTION OF DRAWINGS

For the purpose of illustrating the invention there is shown in the drawings various forms which are presently preferred; it being understood, however, that this invention is not limited to the precise arrangements and instrumentalities particularly shown.

FIG. 1 shows a perspective view of an embodiment of a dual head lamp.

FIG. 2 shows an exploded view of the lamp of FIG. 1.

FIG. 3 shows a perspective view of a battery compartment of the dual head lamp of FIG. 2.

FIG. 4 shows a diagram of a buck boost circuitry in the lamp of FIG. 1 for controlling the voltage supplied to the LEDs.

### DETAILED DESCRIPTION OF THE PREFERRED EMBODIMENTS

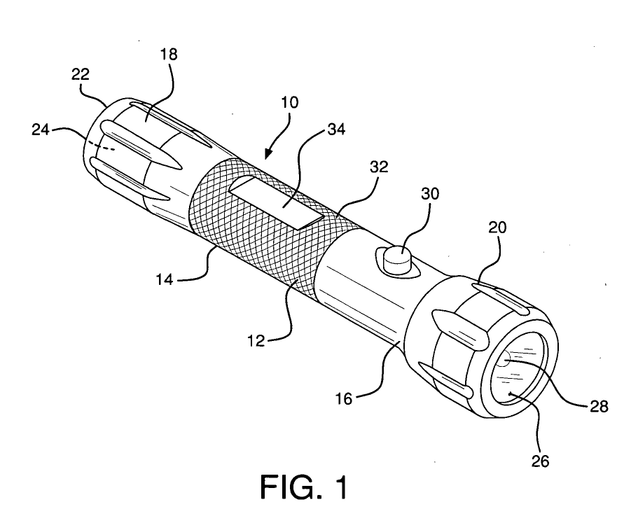

FIG. 1 shows a lamp 10 that includes a housing 12 having a first end 14 and a second end 16. Removably attached to the first end 14 of the housing 12 is a first head 18. The first head 18 includes a first window 22 that protects at least one blue or UV light emitting diode (“LED”) 24. (For simplicity, a blue LED will be discussed in the application. However the present invention is equally applicable to UV LEDs.) The blue LED 24 is configured such that it can emit light through the first window 22 in a direction substantially parallel to the length of the housing 12.

A second head 20 is removably attached to the second end 16 of housing 12. In one embodiment, the second head 20 includes at least one white or other visible LED 28 and a second window 26. (For simplicity, the white or other visible LED will be referred to as a “white LED”.) The white LED 28 is configured to emit light through the second window 26 in a direction substantially parallel to the length of the housing 12 and opposite the direction of the blue LED 24. As noted above, it is also contemplated that one or both of the lamp heads may be mounted on an angle to the housing or a handle portion of the housing.

In an alternate embodiment, the LED in the second head is configured to emit light having a wavelength that is different than the wavelength of light emitted from the LED in the first head. For example, it is contemplated that the LED in the first head may emit UV light and the LED in the second head may emit blue light.

The housing 12 includes a textured area 32 to assist a user in holding the lamp 10. The housing 12 also preferably includes a shelf 34 that aids the user in holding the lamp 10 by providing a depressed or flat area where the user can rest his/her thumb. The shelf 34 is sloped at the end nearest the first end 14 and at the end nearest the second end.

The housing 12 also includes a button 30 for controlling the at least one white LED 28 and the at least one blue LED 24. The button 30 is in communication with a circuit inside the second end 16 of the housing 12. The button 30 is configured to act as a switch for the circuit, allowing the circuit to operate through various stages.

Starting in an “off” position (i.e., no power is provided to either the at least one blue LED 24 or the at least one white LED 28), pressing the button 30 once takes the circuit into a first stage. In the first stage, power is provided to the at least one blue LED 24. In a second stage, which is achieved by pressing the button 30 a second time, the circuit is returned to the “off” position. In a third stage, which is achieved by pressing the button 30 a third time, the one or more batteries 38 provide power to the at least one white LED 28. Pressing the button 30 a fourth time, the circuit is returned to the “off” position, with no power being supplied to either the at least one blue LED 24 or the at least one white LED 28.

Other variations of the staging are also contemplated to be within the scope of the invention. For example, at stage one, power could be provided to the at least one white LED 28; at stage two, power could be provided to the at least one blue LED 24; at stage three, power could be turned off. The particular staging desired can be accomplished by adjusting the circuit.

The circuit preferably includes a current limiting feature that prevents overheating of the LEDs. LEDs are generally driven at a design voltage, such as, for example, 4.6 volts or less. At voltages higher than the design voltage, the risk of overheating of the LEDs increases. To prevent this overheating, the circuit of the present invention preferably limits the current from the batteries (or an A/C or D/C power source) such that the LEDs receive a voltage charge of approximately the design voltage.

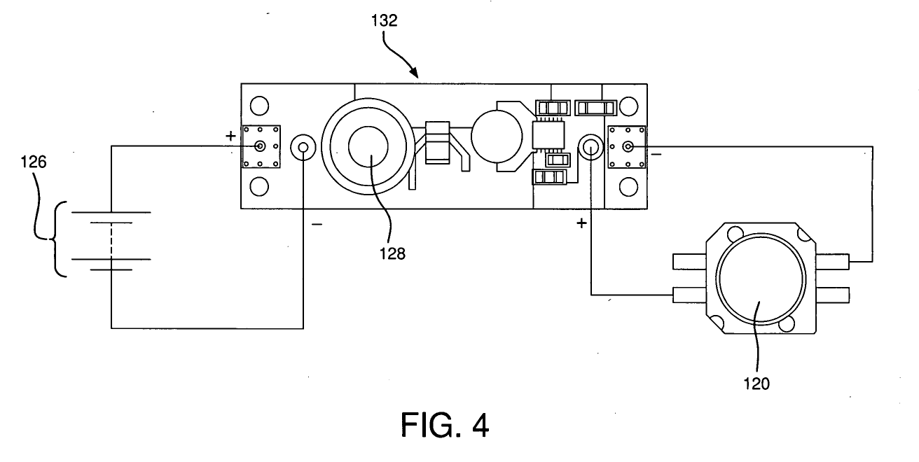

Preferably the housing include buck boost controller, such as the one shown in FIG. 4. The buck boost controller 132 provides an output voltage to at least one LED 120 that can be less than or greater than the input voltage from one or more batteries 126. The buck boost controller can be obtained by a cascade connection of two basic converters: a step down (buck) converter and a step up (boost) converter. A circuit including the buck boost controller is preferably mounted within the housing. The circuit retards or boosts the voltage to the LEDs.

The circuit preferably retards voltage to the LEDs when voltage from the batteries exceeds a first threshold. In one embodiment, the first threshold can be from about 3.6 volts to about 5.6 volts. Preferably, the first threshold is about 4.6 volts.

The circuit preferably boosts voltage to the LEDs when voltage from the batteries drops below a second threshold. In one embodiment, the second threshold can be from about 2.0 volts to about 4.8 volts. Preferably, the second threshold is about 3.8 volts.

The circuit preferably blocks voltage to the LEDs when voltage from the batteries drops below a third threshold. In one embodiment, the third threshold can be from about 1.2 volts to about 4.6 volts. Preferably, the third threshold is about 2.8 volts.

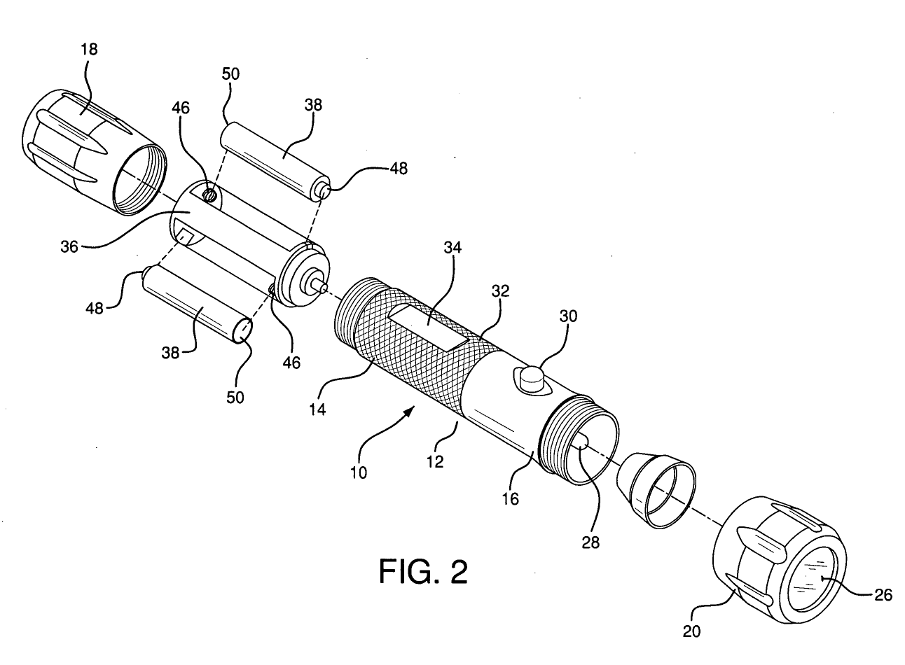

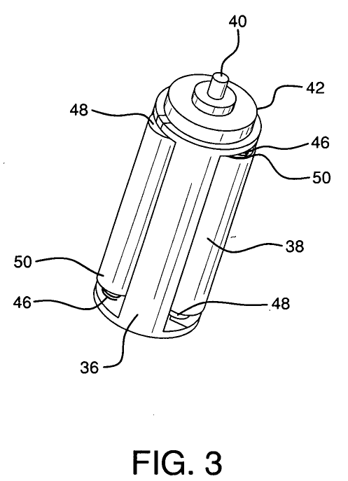

The lamp 10 in the illustrated embodiment is battery powered. As shown in FIGS. 2 and 3, within the housing 12 is a removable battery compartment 36, which is configured to hold one or more batteries. The battery compartment 36 is in communication with LEDs 24/28 and the circuit through a depressible stem 40 on a first side 42 of the battery compartment 36 contacting a conductive element in the housing 12 and through a contact piece on the second side 44 of the battery compartment 38 contacting a second conductive element, for example a spring, in the housing 12.

The battery compartment 36 is structured so that one or more batteries 38 can be housed by snug fit. The battery compartment 36 shown in FIGS. 2 and 3 houses four batteries 38. The batteries 38 are oriented such that two of the batteries 38 have their positive end 48 facing the first side 42 of the battery compartment 36 and the other two batteries 38 have their positive end 48 facing the second side 44 of the battery compartment 36. The negative ends 50 of the batteries are held in place by springs 46 on the battery compartment 36. The battery compartment 36 preferably is made from plastic or other non-conductive or limited conductive material with metal or other conductive materials included in areas where conductivity is required, such as the contacts for the batteries 38.

The housing 12, first head 18, and second head 20 can all be made from the same material. For example, the housing 12, first head 18, and second head 20 can be made from aluminum, aluminum alloy, titanium, titanium alloy, stainless steel, PVC, HDPE, and other similar materials. Alternatively, the housing 12 material can be different from the first head 18 and/or the second head 20 material. For example, the housing 12 may be made from aluminum, while the first head 18 and the second head 20 are made from HDPE.

The textured area 32 provides the user with a gripping area to lessen the ability of the lamp to slip from the user's hand. The textured area 32 can include grooves in the housing 12, raised sections on the housing 12, or a combination of both. The grooves and/or raised sections can be made from the same material as the housing 12. Alternatively, the grooves and/or raised sections can be made from a material that is different than the housing 12 material. For example, the housing 12 may be made from aluminum, while the textured area 32 is made from rubber.

The first window 22 and the second window 26 preferably are made from a durable, transparent material so that the LEDs are protected, but the light emitted from the LEDs is not impeded. For example, the first window 22 and the second window 26 can be made from plexiglass, glass, and other similar materials.

The blue LED can be located in the first head 18 or the second head 20. The white LED can be located in the first head 18 or the second head 20. Where the lamp includes more than one blue LED and/or more than one white LED, the head in which the multiple LEDs reside can include a single window or multiple windows. If multiple windows are present, partitions can be included to separate the windows and the LEDs. The partitions preferably are made from materials that are not heat sensitive. In addition, the partitions preferably are reflective in nature so as to not absorb the light from the LEDs.

As discussed above, the LED in the first head can be a UV LED that emits light in long wave ultraviolet (UV-A) wavelength range of about 320 nm to about 400 nm, for example, around 365 nm, or in the medium wave ultraviolet (UV-B) range from about 280 nm to about 320 nm, for example, around 315 nm, or in the short wave ultraviolet (UV-C) range, for example, around 254 nm. Alternatively, the LED in the first head can be a visible blue LED that emits light in the visible violet/blue range from about 395 nm to about 480 nm within the electromagnetic spectrum.

The lamp 10 is preferably powered by batteries housed in the battery compartment 36. Depending on the size of the lamp 10, the amount and size of the batteries, and the size and orientation of the battery compartment 36 can vary. Preferably, the battery compartment 36 holds four AAA batteries. It is also contemplated that a rechargeable battery can be included in the housing, instead of the disposable batteries. In the event a rechargeable battery is used, a plug socket may be formed in the housing for receiving a plug from an AC or DC charger. It is also contemplated that the power source for powering the LEDs may be line voltage from a cord. As such, the cord would attach to the housing and supply the power necessary to operate the lamp. Conventional circuitry and./or electrical components would be mounted within the housing to convert the line voltage to the voltage necessary to power the LEDs.

While the above discussion referred to one switch for controlling the light sources at both ends, it is also contemplated that there could be two light switches, provided that there is circuitry included that prevents both light sources from being on at the same time.

It will be appreciated by those skilled in the art, that the present invention may be practiced in various alternate forms and configurations. The previously detailed description of the disclosed embodiments is presented for purposes of clarity of understanding only, and no unnecessary limitations should be implied there from.

We claim:

1. A lamp comprising:
a housing having a first end and a second end;
a first head removably attached to the first end, the first head including at least one primary non-white light emitting diode configured to emit light having a wavelength between about 250 nm to about 500 nm through a window of the first head in a first direction substantially parallel to the length of the housing;
a second head removably attached to the second end, the second head including at least one secondary light emitting diode configured to emit light having a wavelength that is different than the wavelength of light emitted by the primary light emitting diode in the first head, the light from the secondary light emitting diode being emitted through a window in the second head in a direction that is not the same as the first direction;
a removable battery compartment located within the housing and in communication with a circuit within the housing, the battery compartment configured to hold one or more batteries; and
a single button in communication with the circuit;
wherein the button and the circuit control power to the primary non-white light emitting diode and the secondary light emitting diode.

2. A lamp of claim 1, wherein the at least one secondary light emitting diode includes at least one white light emitting diode.

3. A lamp of claim 1, wherein the housing has a longitudinal axis and wherein the second head emits light in a direction substantially parallel to the axis of the housing and in a direction opposite to the direction of the light emitted by the primary non-white light emitting diode.

4. A lamp of claim 1, wherein the housing is substantially cylindrical.

5. A lamp of claim 3, wherein the housing is tapered outwardly at the first end, the second end, or both the first end and the second end.

6. A lamp of claim 1, wherein the one or more batteries are reusable batteries.

7. A lamp of claim 1, wherein the circuit limits the current so that no more than about 4.6 volts of power are delivered to the primary and secondary light emitting diodes.

8. A lamp of claim 1, wherein the button is configured as a switch for the circuit where the one or more batteries provide power to the at least one primary light emitting diode in a first stage of the circuit, the one or more batteries provide power to the at least one secondary emitting diode in a second stage of the circuit, and the one or more batteries provide power to neither the at least one primary non-white light emitting diode nor the at least one secondary light emitting diode in a third stage of the circuit.

9. A lamp of claim 8, wherein the circuit further comprises a fourth stage where the one or more batteries provide power to both the at least primary light emitting diode and the at least one secondary light emitting diode.

10. A lamp of claim 1, wherein light emitted from the primary non-white light emitting diode has a wavelength from about 400 nm to about 480 nm.

11. A lamp of claim 1, wherein light emitted from the primary non-white light emitting diode has a wavelength from about 250 nm to about 400 nm.

12. A lamp of claim 11, wherein light emitted from the primary non-white light emitting diode has a wavelength from about 280 nm to about 320 nm.

13. A lamp of claim 11, wherein light emitted from the primary non-white light emitting diode has a wavelength from about 320 nm to about 400 nm.

14. A lamp of claim 1, wherein the circuit retards voltage to the light emitting diode being powered when voltage from the one or more batteries exceeds a first threshold.

15. A lamp of claim 14, wherein the circuit boosts voltage to the to the light emitting diodes being powered when voltage from the one or more batteries drops below a second threshold, and blocks voltage to the light emitting diodes when voltage from the one or more batteries drops below a third threshold.

16. A lamp of claim 1, wherein the circuit comprises a buck boost control circuit with a cascade connection of a step down converter and a step up converter.

17. A lamp of claim 15, further comprising an indicator light that is lit when the voltage drops below the third threshold.

18. A lamp of claim 1, wherein the at least one primary light emitting diode emits light having a wavelength within the UV spectrum, and the secondary light emitting diode emits light having a wavelength within the blue spectrum.
